(19) United States
(12) Patent Application Publication
(10) Pub. No.: US 2026/0338358 A1
(43) Pub. Date: Oct. 29, 2026

(54) LIGHT ASSEMBLY

(71) Applicant: MILWAUKEE ELECTRIC TOOL CORPORATION, Brookfield, WI (US)

(72) Inventors: Chelsea L. Rubietta, Oak Creek, WI (US); Patrick G. Murphy, Milwaukee, WI (US); Victor G. Cinq-Mars, Milwaukee, WI (US); David C. Bartok, Milwaukee, WI (US); Ruslan Budnik, Milwaukee, WI (US); Ryan D. Moorleghen, Milwaukee, WI (US); Austin F. De Veer, Lake Orion, MI (US); Katherine R. Gaylord, Milwaukee, WI (US); Bradford A. Gill, Brookfield, WI (US); Haley N. Stamerra, Milwaukee, WI (US); Joshua A. Ebinger, Oconomowoc, WI (US)

(21) Appl. No.: 19/657,715

(22) Filed: Apr. 24, 2026

Related U.S. Application Data
(60) Provisional application No. 63/794,814, filed on Apr. 25, 2025.

(51) Int. Cl. F21V 21/084; F21L 4/02; F21L 4/08; F21V 21/08; F21V 23/02; F21V 23/04; F21V 23/06; F21Y 105/10; F21Y 115/10

(52) U.S. Cl. CPC F21V 21/084; F21L 4/027; F21L 4/08; F21V 21/0816; F21V 23/023; F21V 23/0428; F21V 23/06; F21Y 2105/10; F21Y 2115/10

(57) ABSTRACT

A light assembly includes a strap forming a loop to be worn by a user. The strap includes a first portion that is adjustable to alter a circumference of the loop and a second portion that has an area light emitter on the outer side of the strap. A light assembly includes a housing coupled to the strap. The light assembly includes a spotlight emitter supported by the housing and pointing in the same direction as the area light emitter. The light assembly includes a battery and circuitry selectively coupling the battery to the area light and to the spotlight. A user interface is operable to control the circuitry to turn on and off each of a first beam of light from the area light emitter and a second beam of light from the spotlight emitter.

### CROSS-REFERENCE TO RELATED APPLICATIONS

This application claims priority to U.S. Provisional Application No. 63/794,814, filed Apr. 25, 2025, the entire contents of which are incorporated by reference herein.

### BACKGROUND

The present application relates to light assemblies, and more particularly to light assemblies with a rechargeable battery.

### SUMMARY

In one embodiment, the disclosure relates to a headlamp including a strap forming a loop and sized to be worn around a head of a user. The strap defines an inner side facing toward the loop and an outer side facing away from the loop. The strap includes a first portion that is adjustable to alter a circumference of the loop and a second portion that has an area light emitter on the outer side of the strap. A housing is coupled to the outer side of the strap and positioned between the first portion and the second portion. The housing includes a user interface and a spotlight emitter supported by the housing and configured to direct in a same direction as the area light emitter. A battery is positioned within the housing. Circuitry selectively couples the battery to the area light emitter and to the spotlight emitter. The user interface is operable to control the circuitry to turn on and off each of a first beam of light from the area light emitter and a second beam of light from the spotlight emitter.

In some aspects, the disclosure relates to a headlamp including a strap configured to form a loop with an adjustable circumference. An elongate area light extends along the strap with an arc angle that is 90° to 180° of the loop and is configured to emit a first beam of light that is wider than the arc angle. A housing is supported by the strap. The housing includes a battery and a spotlight configured to emit a second beam of light in a same direction as that of the first beam of light; and a user interface is configured to control power delivery from the battery to the elongate area light and to the spotlight.

Other aspects of the invention will become apparent by consideration of the detailed description and accompanying drawings.

### BRIEF DESCRIPTION OF THE DRAWINGS

FIG. 1A illustrates a perspective view of an embodiment of a headlamp.

FIG. 1B illustrates a top view of the headlamp of FIG. 1A.

FIG. 1C illustrates a top view of the headlamp of FIG. 1A.

FIG. 2A illustrates a perspective view of an embodiment of a headlamp.

FIG. 2B illustrates a perspective view of an embodiment of a lamp assembly of the headlamp of FIG. 2A.

FIG. 3 illustrates a perspective view of an embodiment of a task light.

FIG. 4A illustrates a top view of an embodiment of a foldable light.

FIG. 4B illustrates a perspective view of the foldable light of FIG. 4A.

FIG. 4C illustrates another perspective view of the foldable light of FIG. 4A.

FIG. 4D illustrates another perspective view of the foldable light of FIG. 4A.

FIG. 5A illustrates a perspective view of an embodiment of a light assembly.

FIG. 5B illustrates a side view of the light assembly of FIG. 5A.

FIG. 6A illustrates a perspective view of an embodiment of a light assembly.

FIG. 6B illustrates another perspective view of the light assembly of FIG. 6A.

### DETAILED DESCRIPTION

Before any embodiments of the invention are explained in detail, it is to be understood that the invention is not limited in its application to the details of construction and the arrangement of components set forth in the following description or illustrated in the following drawings. Additionally, the components of each arrangement are interchangeable with comparable components in alternative arrangements. The invention is capable of other embodiments and of being practiced or of being carried out in various ways.

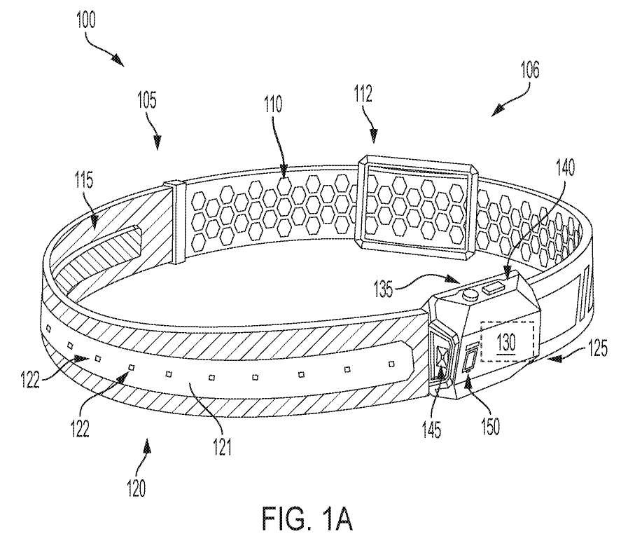

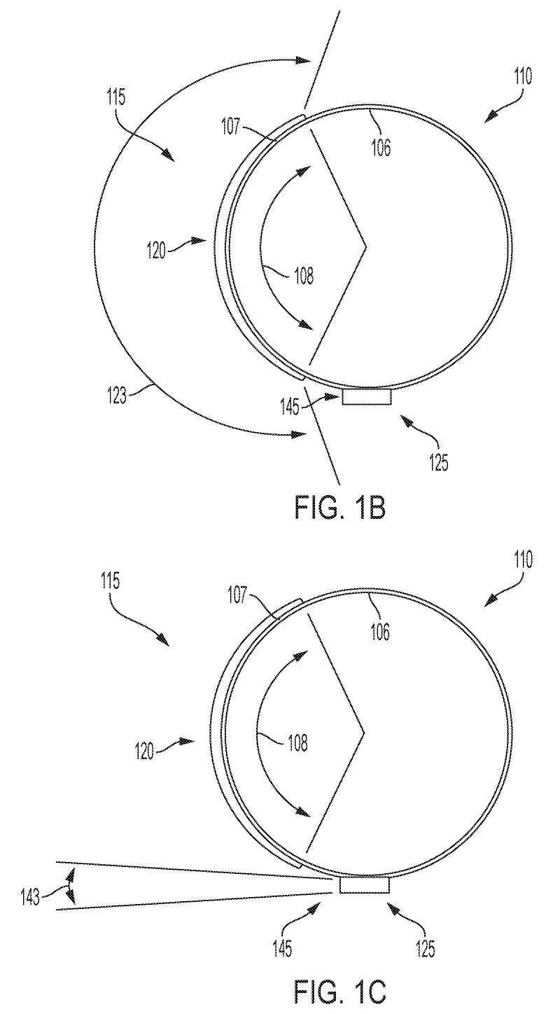

FIG. 1A, 1B and 1C illustrate a headlamp 100 for placing around the head or hat of a user. In some examples, a hat can include a baseball hat or hardhat. The headlamp 100 includes a strap 105 and a housing 125. The strap 105 defines an inner side of the strap 105 that engages with the head or hat of a user. The strap 105 defines an outer side of the strap 105 that engages with the housing 125 and an area light emitter 120. The strap 105 forms a loop 106 and the length or circumference of the loop 106 can be selectively adjusted (e.g. sized or altered) to fit snugly around a head or a hardhat of a user such that the headlamp 100 is held in place on the head or hardhat. A first portion 110 of the strap 105 is adjustable to alter the size of the loop 106. The first portion 110 is adjustable via a sliding connector 112. The first portion 110 may be made from fabric, such as an elastic band that stretches or a strip of webbing. Additionally, the first portion 110 may include a friction-material on a side of the strap that engages with the head or hat of the user (e.g. on the inside of the strap). The friction-material is, for example, a rubber, suede, or other material, layer, or texture applied to, woven into, or from which the strap is made.

A second portion 115 of the strap 105 includes the area light emitter 120, which extends elongate around a portion of the loop 106. The second portion 115 is made from a deformable material that can conform to follow the contours of the head or hat of a user. In some examples, the second portion 115 is a stretchable and/or friction-material, such as rubber or an elastic fabric. In some examples, the area light emitter 120 includes an array of light emitting diodes (LEDs) 122. As illustrated, the area light emitter 120 includes a light panel 121 that is flexible. The light panel 121 includes a line of LEDs 122 that are spaced apart along the second portion 115. In some examples, the headlamp 100 is arranged in a generally circular loop 106 with the area light emitter 120 facing outward along an arc 107 of the loop 106; in other words, the area light emitter 120 corresponds to the arc 107. The area light emitter 120 casts a beam of light with an angle 123 of illumination that is broader than the angle 108 of the arc 107 of the area light emitter 120 (measured from a center of the loop 106). The angle 123 of the beam of light is wider than the angle 108 of the arc 107. The width or angle 123 of the beam of light depends on the contour the second portion 115 follows. In one example, the arc 107 of the area light emitter 120 spans between 1/4 to 1/2 (90° to 180°) of the loop 106 and an angle 123 of the beam of light illuminates at least 180° in front of the headlamp 100.

The headlamp 100 also includes a housing 125 coupled to the outside of the strap 105 located near the transition between the first portion 110 and the second portion 115 of the strap 105. For example, as illustrated, the housing 125 is between and connects the first portion 110 and the second portion 115. Alternatively, the housing 125 is positioned on the second portion 115 of the strap 105 between the area light emitter 120 and the first portion 110. Alternatively, the housing 125 is positioned on the first portion 110. The housing 125 includes a cavity with a battery 130 disposed and supported inside the cavity and configured to control delivery of power to various components of the headlamp 100. The battery 130 is a rechargeable battery, and can be rechargeable via a USB-C connection—the USB-C connection is supported by the housing 125. In some embodiments, the battery 130 is not removable, while in other embodiments, the battery 130 is removable. The housing 125 can further include a spotlight emitter 145, which projects a beam of light with an illumination angle 143 that is narrower than the illumination angle 123 of the beam of light from the area light emitter 120. The spotlight emitter 145 can include a light emitting diode (LED). As illustrated, the spotlight emitter 145 is supported by the housing 125 on a side of the housing 125 that is perpendicular to the strap 105, with the beam of light from the spotlight emitter 145 generally configured to be in the same direction as the beam of light from the area light emitter 120. In other words, while the headlamp 100 is worn on a head of a user with the area light emitter 120 pointing forward, the housing 125 is adjacent a side of the user’s head and the spotlight emitter 145 illuminates in the forward direction. The spotlight emitter 145 and the area light emitter 120 are powered by the battery 130. The housing 125 also includes a user interface 135, which includes buttons 140 that operate to control the headlamp 100, e.g., to turn on and off the area light emitter 120 and/or turn on and off the spotlight emitter 145. The housing 125 further includes an indicator 150, which in some examples is an LED. The indicator 150 can indicate that the battery 130 is charging, a charge level of the battery 130, and/or provide other feedback to the user. Circuitry connects the battery 130 to the area light emitter 120, spotlight emitter 145, and user interface 135 and may selectively supply power from the battery 130 to the headlamp 100. The circuitry may include wire, a circuit board, and/or other electrical components. In some embodiments, the headlamp 100 has properties equivalent to IP54 dust and splash protection.

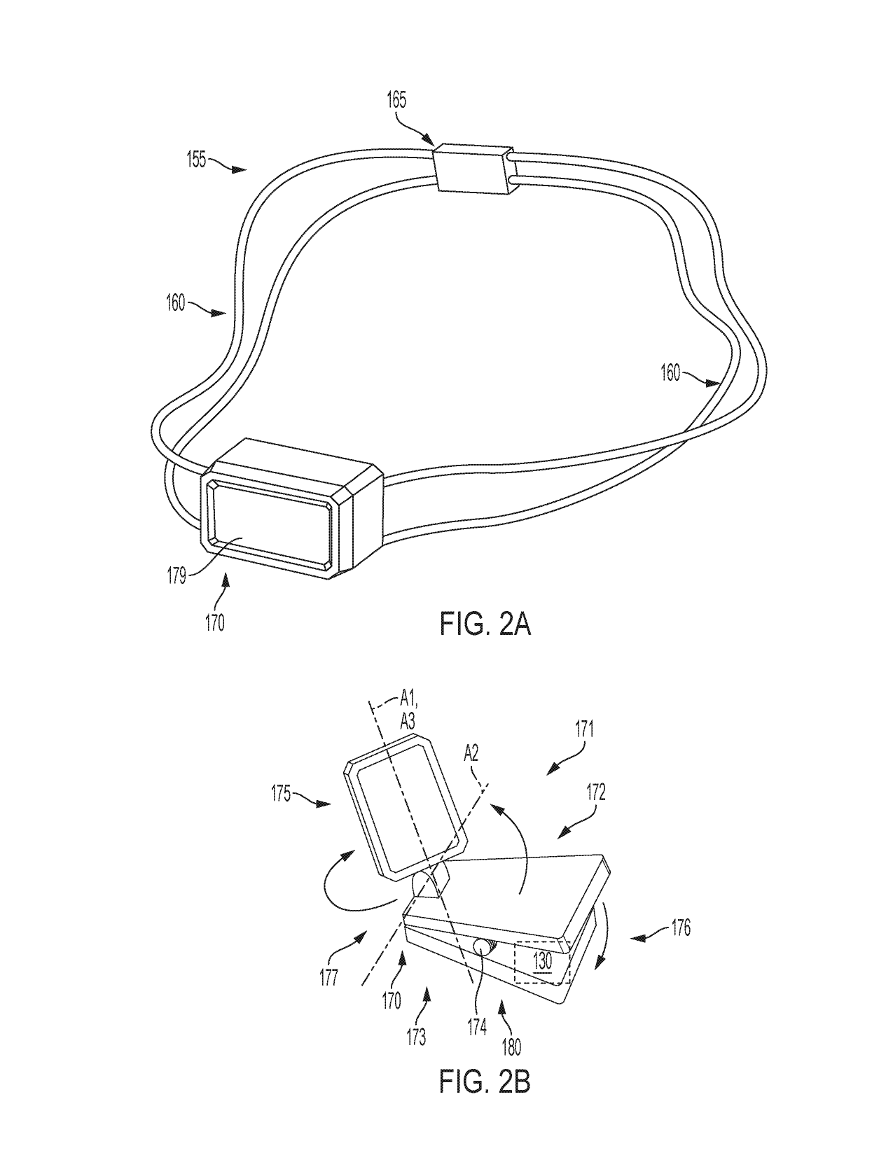

FIGS. 2A and 2B illustrate another example of a headlamp 155. The headlamp 155 includes a bungee cord strap 160 that connects a tension adjuster 165 and a lamp assembly 170. The tension adjuster 165 is operable to adjust the circumference of the headlamp 155 by adjusting the length of the bungee cord strap 160. The lamp assembly 170 includes a first portion 175 including the lamp 179, which can include LEDs to emit light. The lamp assembly 170 further includes a second portion 180 that is pivotably connected to the first portion 175. The second portion 180 is connected to the bungee cord strap 160 and houses a battery 130. The second portion 180 includes a clamp 171 with a first half 172 coupled to a second half 173 opposite the first half 172 and pivotably connected by a fulcrum 174. The clamp 171 includes a clamping end 177, an operable end 176 opposite the clamping end 177. The first half 172 and second half 173 are biased toward each other at the clamping end 177. The first half 172 and second half 173 at the clamping end 177 can be forced apart by squeezing the first half 172 and second half 173 toward each other on the operable end 176. The lamp assembly 170 may be pivotably connected to the second portion 180 around a first axis A1 that passes through the first half 172 and the second half 173, around a second axis A2 that is parallel to the first half 172, or the second axis A2 and a third axis A3 perpendicular to the second axis A2 (as illustrated the first axis A1 overlaps the third axis A3 and the third axis A3 intersects and rotates around the second axis A2). The battery 130 is a rechargeable battery, and can be rechargeable via a USB-C connection. In some embodiments, the battery 130 is not removable, while in others, the battery 130 is removable. The second portion 180 can include two halves that can be squeezed and clamped together.

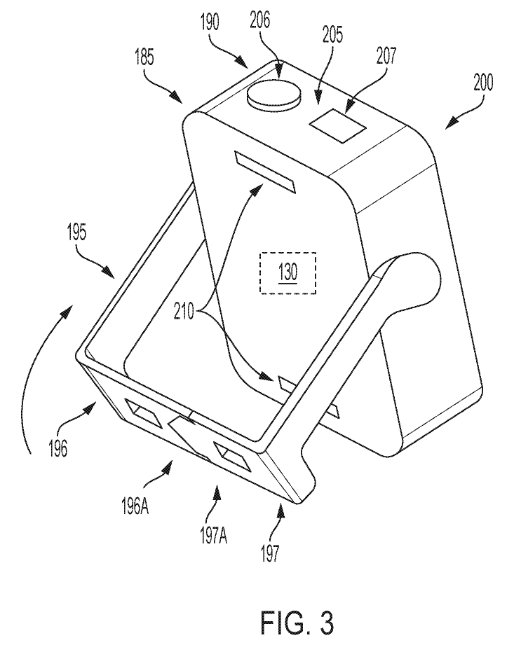

FIG. 3 illustrates a task light 185. The task light 185 includes a housing 190 and a stand 195. The stand 195 is pivotable toward and away from the housing 190 such that the housing 190 leans against the stand 195 to generally direct light from a light emitter 200. The task light 185 can be supported on a surface by portions of the housing 190 and/or the stand 195. Thus, changing the position of the stand 195 can change the direction of the light from the light emitter 200. The stand 195 includes legs 196 and 197, which are independently articulatable such that they can pivot relative to the housing 190 independently of one another. The legs 196 and 197 can couple together by interlocking with interlocking portions 196A and 197A. The interlocking portions 196A and 197A may include fiction surfaces, magnets, and the like. The legs 196 and 197 are on opposing sides of the task light 185 adjacent a side of the task light 185 where the emitter 200 is located. In some examples, the light emitter 200 includes an LED and/or an array of LEDs.

The housing 190 includes the battery 130. The battery 130 is a rechargeable battery, and can be rechargeable via a USB-C connection. In some embodiments, the battery 130 is not removable, while in others, the battery 130 is removable. The housing 190 also includes a user interface 205 including, for example, a button 206 and/or an indicator 207 (e.g. an LED indicator), which allow a user to control the task light 185. As illustrated, the user interface 205 is consolidated on one side of the task light 185. In the example provided herein, the user interface 205 is located adjacent the side of the task light 185 where the emitter 200 is located, although other examples are contemplated. In other examples, the user interface 205 is spread across multiple portions of the task light 185. Magnets 210 are also provided on the exterior of the housing 190, which can be used to mount the task light 185 to a metal structure. In the present example, the magnets 210 are positioned on a side of the task light 185 opposite the light emitter 200. The magnets 210 may additionally or alternatively be positioned on other sides of the task light 185 and/or on the legs 196 and 197.

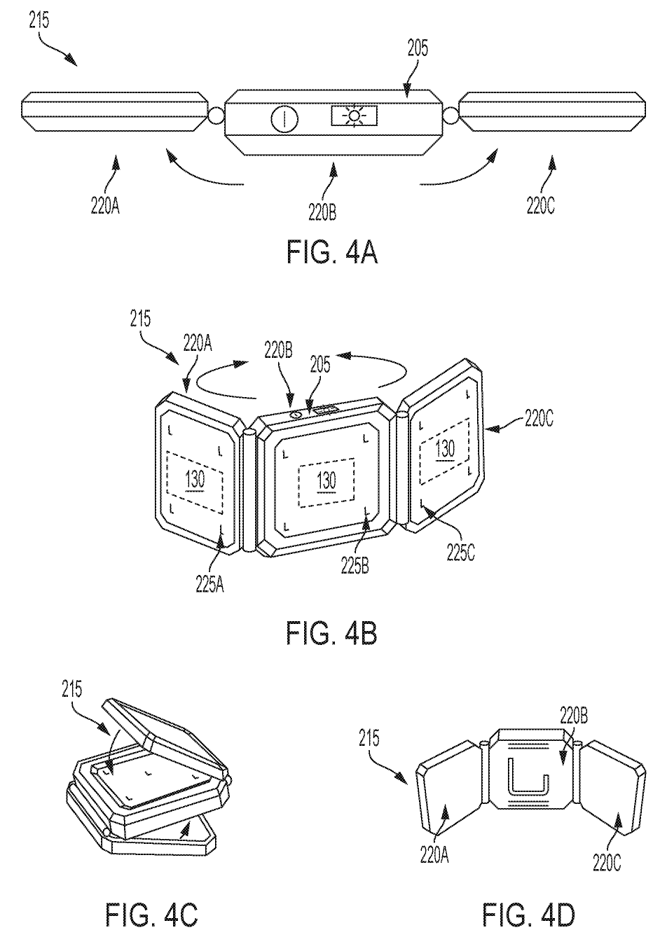

FIGS. 4A, 4B, 4C, and 4D, illustrate multiple views of a foldable light 215. The foldable light 215 includes three panels 220A, 220B, and 220C that are pivotably connected in series. FIGS. 4A, 4B, 4C, and 4D, illustrate numerous different positions of the three panels 220A, 220B, and 220C folded relative to one another. Each of the panels 220A, 220B, and 220C includes a respective emitter 225A, 225B, and 225C, which can include, for example, LEDs to emit light. One or more of the panels 220A, 220B, and 220C further includes a user interface 205 including, for example, buttons and/or an indicator (e.g. an LED indicator), which allow a user to control the foldable light 215 and communicates to the user information about the status of the foldable light 215. One or more of the panels 220A, 220B, and 220C further includes the battery 130, which powers one or more of the emitters 225A, 225B, and 225C. The battery 130 is a rechargeable battery, and can be rechargeable via a USB-C connection. In some embodiments, the battery 130 is not removable from the foldable light 215, while in others, the battery 130 is removable.

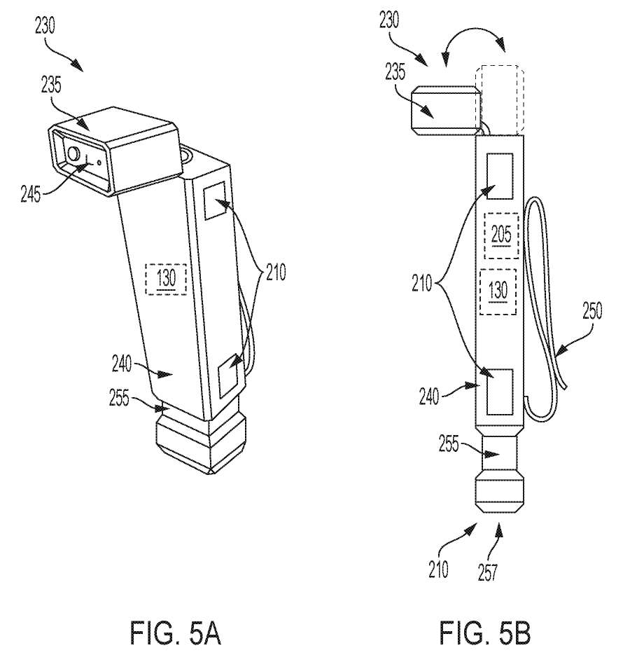

FIGS. 5A and 5B illustrate a light assembly 230. The light assembly 230 includes a first housing portion 235 and a second housing portion 240. The first housing portion 235 includes an emitter 245, which in some examples is an LED and/or an LED array. The first housing portion 235 is pivotably connected to the second housing portion 240. The second housing portion 240 includes the battery 130, which powers the emitter 245. The battery 130 is a rechargeable battery, and can be rechargeable via a USB-C connection. In some embodiments, the battery 130 is not removable from the light assembly 230, while in others, the battery 130 is removable. The second housing portion 240 also includes a user interface 205 including, for example, buttons and/or an indicator (e.g. an LED indicator), which allow a user to control the light assembly 230 and communicates information about the status of the light assembly 230. Magnets 210 are also provided on the exterior of the second housing portion 240, which can be used to mount the light assembly 230 to a metal structure. The magnets 210 are located on a side face of the second housing portion 240. Magnets 210 are also included on end face 257 of the light assembly 230. The end face 257 is at an end of the second housing portion 240 opposite from the first housing portion 235 where an indented zone 255 is located. In the indented zone 255, the exterior of the second housing portion 240 is inset relative to the rest of the second housing portion 240. The indented zone 255 can be used, for example, to allow a user to better grip the light assembly 230. A clip 250 is also provided on the exterior of the second housing portion 240, which can be used to mount the light assembly 230 on various other structures--for example, a belt.

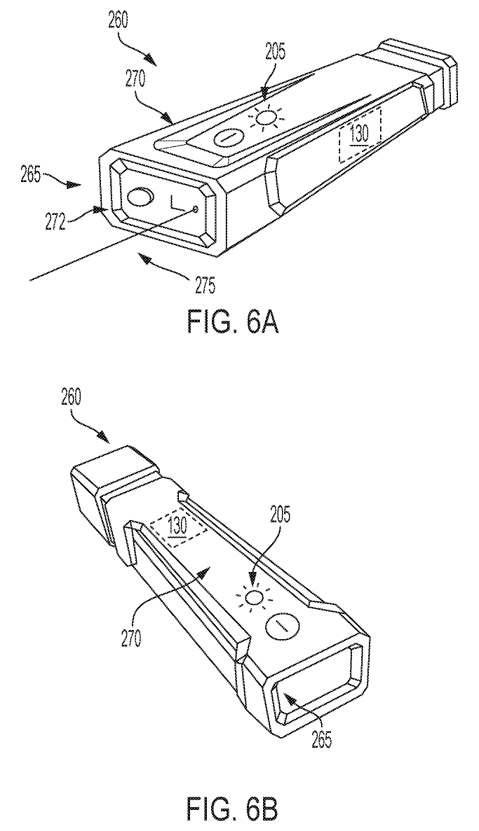

FIGS. 6A and 6B illustrate another example of a light assembly 260. The light assembly 260 is rectangular in shape, and includes at least a first face 265 and a second face 270. The first face 265 includes a light emitter 272, for example an LED and/or an array of LEDs. The first face 265 also includes a laser 275. The second face 270 includes a user interface 205 including, for example, buttons and/or an indicator (e.g. an LED indicator), which allow a user to control the light assembly 260 and communicates information about the status of the light assembly 260. The first and second faces 265, 270 can be any of the faces of the generally rectangular structure of the light assembly 260. The light assembly 260 further includes the battery 130, which powers the emitter 272 and laser 275 on the first face 265. The battery 130 is a rechargeable battery, and can be rechargeable via a USB-C connection. In some embodiments, the battery 130 is not removable from the light assembly 260, while in others, the battery 130 is removable.

Although the disclosure includes reference to certain preferred embodiments, variations and modifications exist within the scope and spirit of one or more independent aspects of the disclosure as described. Various features of the disclosure are included in the following claims.

What is claimed is:

1. A headlamp comprising:
a strap forming a loop and sized to be worn around a head of a user, the strap defining an inner side facing toward the loop and an outer side facing away from the loop, and the strap including:
a first portion that is adjustable to alter a circumference of the loop, and
a second portion that has an area light emitter on the outer side of the strap;
a housing coupled to the outer side of the strap and positioned between the first portion and the second portion, the housing including a user interface;
a spotlight emitter supported by the housing and configured to direct light in a same direction as the area light emitter;
a battery positioned within the housing; and
circuitry selectively coupling the battery to the area light emitter and to the spotlight emitter;
wherein the user interface is operable to control the circuitry to turn on and off each of a first beam of light from the area light emitter and a second beam of light from the spotlight emitter.

2. The headlamp of claim 1, wherein the first portion comprises an elastic fabric that is stretchable to alter the circumference of the loop.

3. The headlamp of claim 1, wherein the first portion includes a sliding connector configured to adjust the circumference of the loop.

4. The headlamp of claim 1, wherein the strap includes a friction-material on the inner side of the strap.

5. The headlamp of claim 1, wherein the second portion is made from flexible material configured to conform to contours adjacent the inner side of the strap.

6. The headlamp of claim 5, wherein the second portion includes at least one of a stretchable material and a friction-material.

7. The headlamp of claim 6, wherein the second portion includes rubber.

8. The headlamp of claim 5, wherein the area light emitter includes a flexible light panel.

9. The headlamp of claim 8, wherein the flexible light panel includes an array of light emitting diodes (LEDs).

10. The headlamp of claim 1, wherein, when the strap is arranged in a generally circular loop, the area light emitter corresponds to an arc of the loop with an arc angle measured from a center of the loop, the arc is 1/4 to 1/2 of the circumference of the loop, and an angle of illumination of the first beam of light is broader than the arc angle.

11. The headlamp of claim 10, wherein the angle of illumination is at least 180°.

12. The headlamp of claim 1, wherein the housing includes a cavity, and wherein the battery is disposed within the cavity.

13. The headlamp of claim 1, wherein the battery is rechargeable via a USB-C connection supported by the housing.

14. The headlamp of claim 1, wherein the second beam of light is narrower than the first beam of light.

15. The headlamp of claim 1, wherein the spotlight emitter includes a light emitting diode (LED).

16. The headlamp of claim 1, wherein, when the strap is arranged in a generally circular loop, the second beam of light points in a same direction as the first beam of light.

17. The headlamp of claim 1, wherein the user interface includes at least one button that is operable to turn on and off the area light emitter and to turn on and off the spotlight emitter.

18. The headlamp of claim 1, further comprising an indicator supported by the housing.

19. The headlamp of claim 18, wherein the indicator includes a light emitting diode (LED).

20. A headlamp comprising:
a strap configured to form a loop with an adjustable circumference;
an elongate area light extending along the strap with an arc angle that is 90° to 180° of the loop and configured to emit a first beam of light that is wider than the arc angle;
a housing supported by the strap and including a battery and a spotlight configured to emit a second beam of light in a same direction that as that of the first beam of light; and
a user interface configured to control power delivery from the battery to the elongate area light and to the spotlight.
